(19) United States
(12) Patent Application Publication
(10) Pub. No.: US 2014/0240214 A1
(43) Pub. Date: Aug. 28, 2014

(54) Glove Interface Apparatus for Computer-Based Devices

(71) Applicants: Jiake Liu, Huntsville, AL (US); Chris Heath, Madison, AL (US); Stephen Doud, Decatur, AL (US); Douglas Kirby, Madison, AL (US)

(72) Inventors: Jiake Liu, Huntsville, AL (US); Chris Heath, Madison, AL (US); Stephen Doud, Decatur, AL (US); Douglas Kirby, Madison, AL (US)

(21) Appl. No.: 13/777,479

(22) Filed: Feb. 26, 2013

(51) Int. Cl. G06F 3/01

(52) U.S. Cl. CPC G06F 3/014
USPC 345/156

(57) ABSTRACT

A glove interface apparatus for computer-based devices includes a glove having a plurality of contacts and a thumb contact that together render a completed electrical circuit when the thumb contact touches any of the plurality of contacts. Each of the resulting circuits is configured to present a unique voltage which is coupled to a processor which determines a character signal representative of the unique voltage and transmits that signal to a compatible computer-based device.

### BACKGROUND

### Field

The present invention relates generally to wireless communications interfaces with computer-based devices.

### SUMMARY

A glove interface apparatus for computer-based devices includes a glove having a plurality of contacts and a thumb contact that together render a completed electrical circuit when the thumb contact touches any of the plurality of contacts. Each of the resulting circuits is configured to present a unique voltage which is coupled to a processor which determines a character signal representative of the unique voltage and transmits that signal to a compatible computer-based device.

### BRIEF DESCRIPTION OF THE DRAWINGS

The present invention is described with reference to the accompanying drawings. In the drawings, like reference numbers indicate identical or functionally similar elements.

FIG. 1 shows a palmar view of an exemplary glove apparatus;

FIG. 2 shows a dorsal view of the exemplary glove apparatus of FIG. 1;

FIG. 3 is a schematic of an exemplary impedance array of the glove apparatus for generating unique voltages when a circuit is completed between the thumb contact and any of the remaining eight contacts;

FIGS. 4, 5 & 6 depict exemplary layout of English characters for a glove interface apparatus;

FIGS. 7 and 7A illustrate an exemplary circuit board configuration and an exemplary operational signal flow, respectively;

FIG. 8 presents further exemplary embodiments of the glove interface apparatus incorporating a near-field communications system and motion sensor;

FIG. 9 illustrates yet further exemplary embodiments of the glove interface apparatus equipped with a speaker, a video display and a microphone; and

FIG. 10 is a functional block diagram of an exemplary computer-based system.

### DETAILED DESCRIPTION

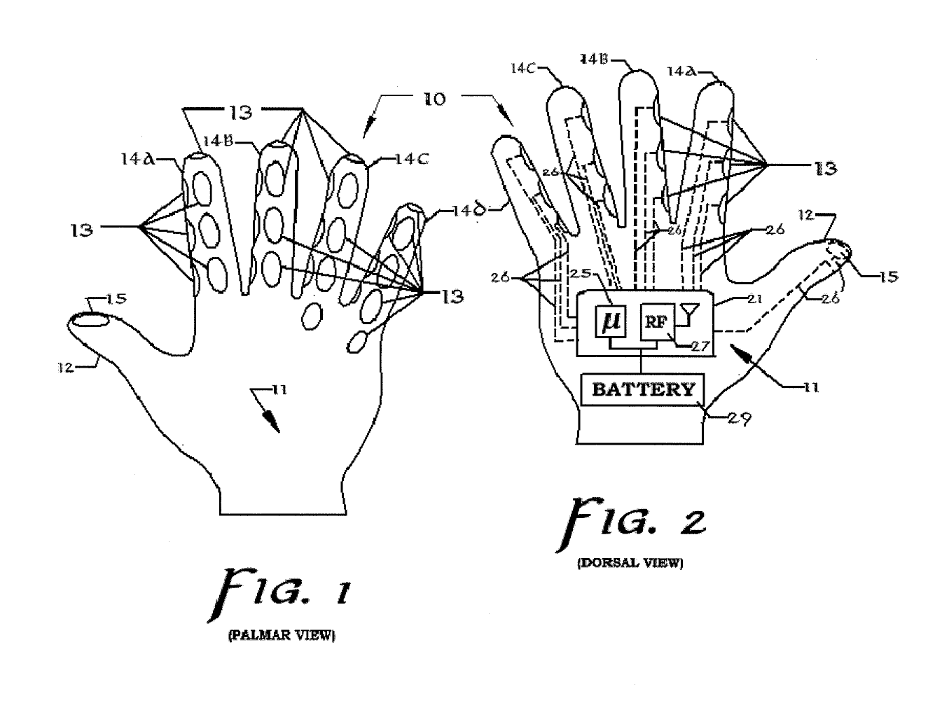

The various embodiments of the glove interface apparatus and their advantages are best understood by referring to FIGS. 1 through 10 of the drawings. The elements of the drawings are not necessarily to scale, emphasis instead being placed upon clearly illustrating the principles of the invention. Throughout the drawings, like numerals are used for like and corresponding parts of the various drawings.

For the purposes of this description, terms of spatial orientation such as “palmar,” “dorsal,” “distal,” “proximal,” “lateral,” “medial,” “sagittal,” “anterior,” “posterior,” and variants thereof shall be used according to their commonly understood anatomical definitions. Specifically, the term “lateral” shall be understood to mean the radial, or “thumb-ward” side of the hand, and “medial” shall be understood to mean the ulnar side of the hand. Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

The principles embodied in the glove interface apparatus described hereafter may assume various alternative orientations, layouts, and step sequences, except where expressly specified to the contrary. It is also to be understood that the specific devices and processes illustrated in the attached drawings, and described in the following specification are only exemplary embodiments of the inventive concepts defined in the appended claims. Hence, specific dimensions and other physical characteristics relating to the embodiments disclosed herein are not to be considered as limiting, unless the claims expressly state otherwise.

With the above in mind, an exemplary glove interface apparatus 10 for computer-based devices embodying the principles of the invention includes a glove substructure 11 comprising a flexible, resilient fabric which may comprise a polymeric material. A thumb contact pad 15 is located on the tip of the thumb 12 of the glove 11 and a plurality of finger pads 13 are distributed along the fingers 14a-d, and the palm.

The thumb pad 15 and the finger pads 13 (collectively, the “pads”) are formed from a flexible, electrically-conductive filament, for example, conductive thread, e.g., silver-plated nylon, and are incorporated onto, or integrated within, the substructure of the glove 11. Each of the pads 13, 15 are coupled to a circuit board 21 through arrays of conductive threads 26 which, like the pads 13, 15, may be incorporated onto the glove substructure 11 or integrated within it. The circuit board 21 supports a microcontroller 25 and a wireless RF module 27, preferably Bluetooth® protocol-compatible. The glove 10 also includes a battery 29 to provide power to the microprocessor 25 and the RF Module 27.

The microcontroller 25 may be one or more computer-based processors and can be implemented by a field programmable gated array (FPGA), application specific integrated chip (ASIC), central processing unit (CPU) with memory, or other logic device. A processor in effect comprises a computer system. Such a computer system can include, for example, one or more processors that are connected to a communication bus. The computer system can also include a main memory, preferably a random access memory (RAM), and can also include a secondary memory comprising a computer-readable storage medium having stored therein computer software and/or data.

Computer programs (also called computer control logic) are stored in the main memory and/or secondary memory. Computer programs can also be received via the communications interface. Such computer programs, when executed, enable the computer system to perform certain features of the present invention as discussed herein. In particular, the computer programs, when executed, enable a processor to perform and/or cause the performance of features of the glove interface apparatus.

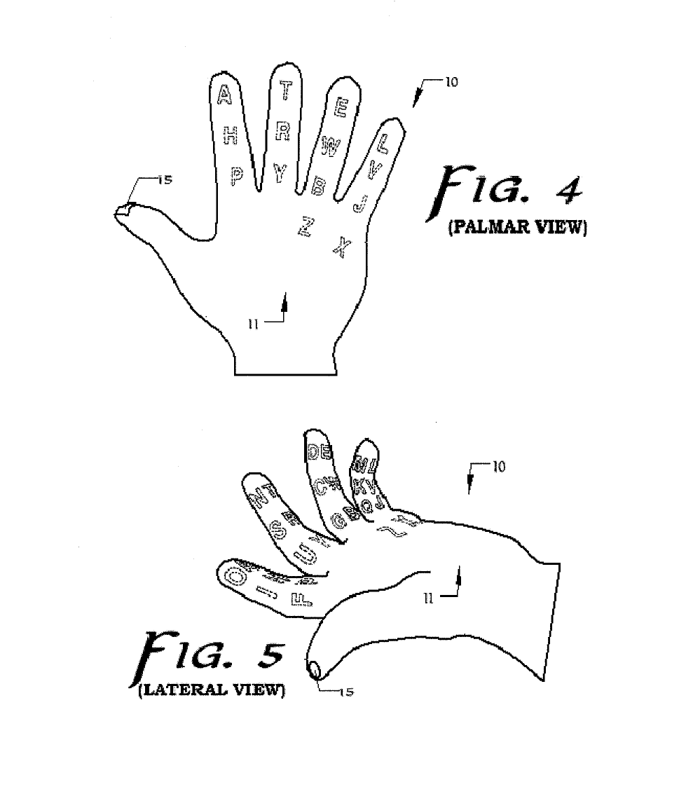

The contact pads 13, 15 are each connected to one or more impedance arrays 30, an example of which is shown in FIG. 3. An exemplary impedance array 30 comprises pads 1 through 8 (which are the finger pads 13 distributed along either the pinky 14c, or ring fingers 14d) coupled to resistors R1-R8 (or other impedance components), the impedances of which are each unique. When the thumb pad 15 contacts any of pads 1 through 8, a circuit is closed manifesting a voltage drop that is sampled by the microcontroller 25 in each case. Since each pad is coupled to the array in a unique relation to the overall impedance, the voltage (V1 through V8) presented to the microcontroller 25 is unique in each circumstance, thereby allowing identification of the individual pad in contact with the thumb pad 15.

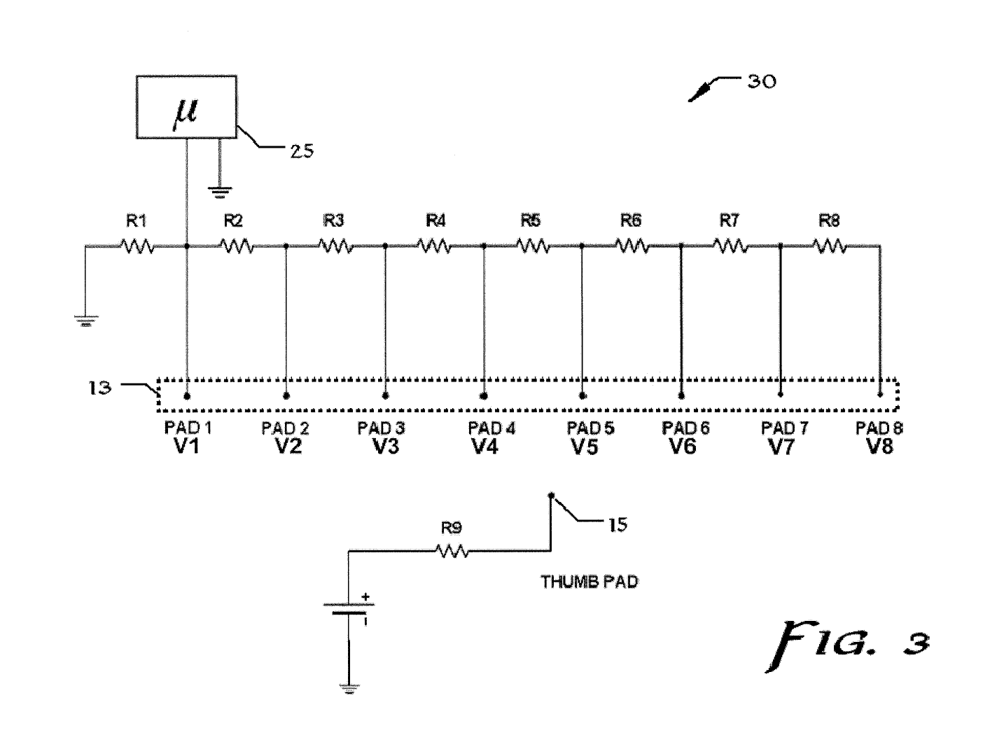

Returning to FIGS. 1 and 2, finger contacts 13 are advantageously distributed along the fingers 14a-d of the glove 11 with three pads 13 disposed longitudinally along the palmar face of each finger, and three pads 13 disposed longitudinally along the lateral face of each finger. In addition, a pad 13 is located at the tip of each finger, and two pads are located in the palm adjacent the ring and pinky fingers. Thus, the thumb tip, and the thumb pad 15, are easily able to be brought into contact with each finger pad 13.

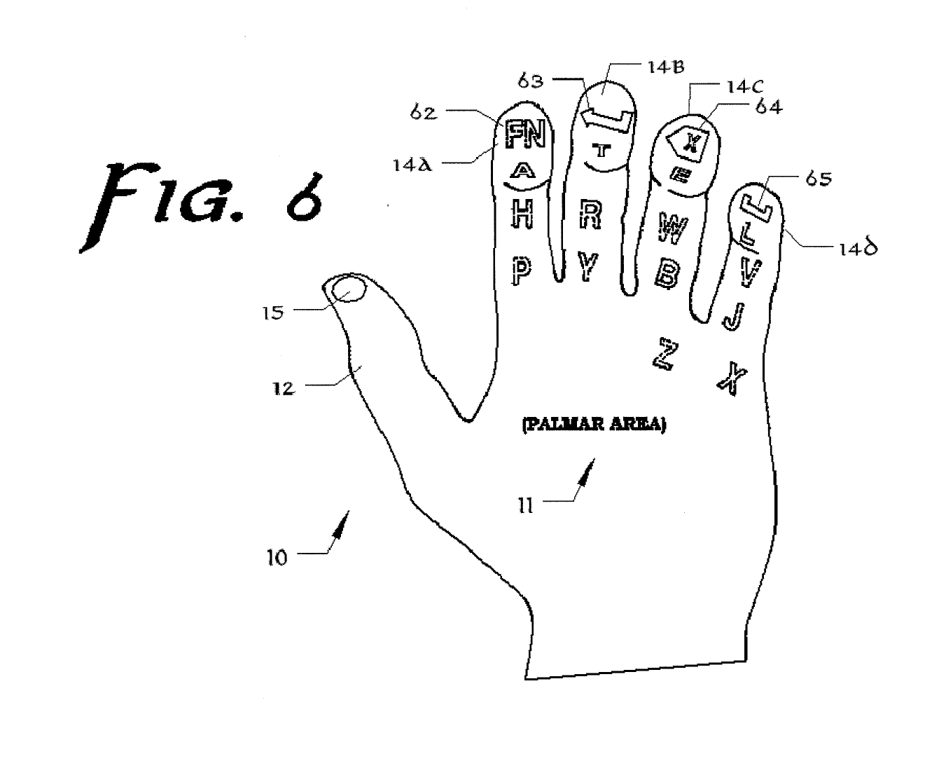

FIG. 4 through 6 depict an exemplary character layout. The pads 13 are formed in the shapes of the desired characters. In this example, the layout is prioritized according to frequency of character use in the language, with more frequently used characters being located in the positions most easily accessible by the thumb. Conversely, the least used characters are located in the least easily accessed positions. Accordingly, the layout shown in the figures, assuming the input language is English, positions letters, O, A, N, T, D, E, M, and L on the palmar and lateral faces of the distal ends of the fingers 14a-d. In comparison, letters Z and X, the least used in the English language, are located on the palm adjacent the ring 14c and pinky fingers 14d. FIG. 6 illustrates positions of four other character keys, namely, “FN” or “Function” 62, “Enter/Return” 63, “Backspace,” 64 and “Space” 65. In this example, each is located on the tips of fingers 14a through 14d respectively. Of course, those skilled in the relevant arts will appreciate that other languages or characters may be used. Preferably, the distribution of such characters is such at the most used characters of the chosen language will be located along the fingers of the glove according to a priority dictated by the frequency of a character's use in that language, such that the more frequently used characters are reachable by the thumb and thumb contact with the least amount of strain or effort.

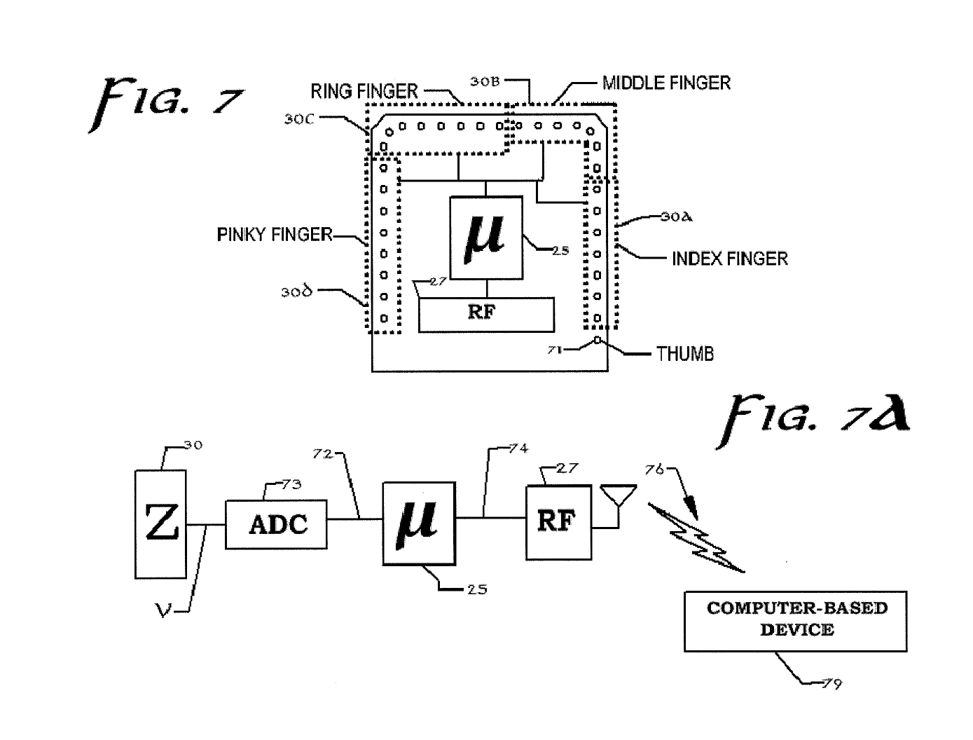

A functional diagram of an exemplary circuit board 21 is provided in FIGS. 7, and 7A. In this embodiment, there are separate impedance arrays 30a-d for each finger which are distributed about the circuit board 21, and a single impedance terminal provided for the thumb. It will be appreciated by those skilled in the relevant arts that care must be taken to prevent the conductive threads 26 from contacting one another, especially at the terminal points on the circuit board 21. Impedance arrays 30a-30d and the thumb terminal 71 are coupled to the microcontroller 25, which in turn is coupled to the wireless RF module 27. In operation, when the thumb pad 15 contacts any of the character pads 13, the circuit created results in a unique identifiable voltage drop (e.g., FIG. 3: V1 through V8), as described above, and these voltages V from the arrays 30 are sampled by the ADC 73 which outputs a digital signal 72 representative of the sampled voltage to the microcontroller 25. The microcontroller 25 includes a computer-readable memory configured data that associates a unique character with a unique voltage. The microcontroller is also configured with control logic that allows the microcontroller to identify which character was selected based on the digital signal 72 received from the ADC 73. In an alternative embodiment, the microcontroller may be configured to output a signal representing a phrase of characters based upon certain unique voltage inputs or sets of unique voltage inputs.

The microcontroller 25 then outputs a character signal 74 to the wireless RF module 27 which is, in turn, in wireless communication 76 with a computer-based device 79, e.g., a desktop or laptop computer, a smartphone, PDA, or any other computing device with a compatible communication module linked to the RF module 27. Consequently, the character signal serves as input for the computer-based device 79 for messaging, word processing, and the like.

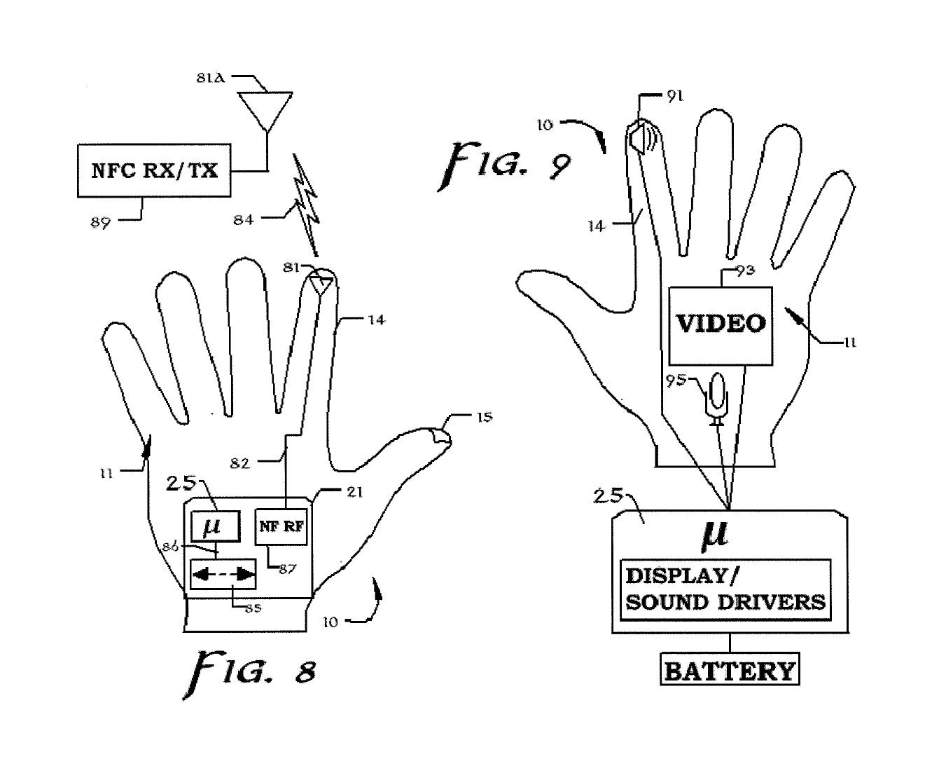

Another embodiment of the glove interface apparatus is illustrated in FIG. 8. The glove substructure 11 includes a near-field communications (NFC) antenna 81 located in a tip of a finger 14. The NFC antenna 81 is preferably embedded in or incorporated into the glove structure 11 and is coupled to an NFC RF module 87 that may also be resident on the circuit board 21 and responsive to, or part of the microcontroller 25. In this embodiment, the NFC RF module 87 is configured to output an NFC signal 82 to the antenna 81 that is designed to couple the NFC signal 84 to a corresponding near-field antenna 81a which receives the signal and couples it to an NFC transceiver 89.

A further embodiment includes motion sensor 85 coupled to the microcontroller 25. The motion sensor may be implemented with, for example, a 2- or 3-plane accelerometer, and configured to detect certain movements of the glove apparatus that may be used as input commands. For example, such a motion sensor could be configured to generate a signal 86 when a horizontal, left-to-right “slicing” motion is detected. The microcontroller 25 receives the motion signal 86 as input. The microcontroller 25 is configured with control logic as described above to identify the motion signal 86 and generate an appropriate command signal output to the RF module 27 as described above. It will be understood, therefore, that the microcontroller 25 memory will include data that also provides corresponding relationships between detected motions and commands to be output to the RF module 27 for transmission to the computer-based device to which the glove apparatus is coupled. Thus, a left-to-right slicing motion of the glove may correspond to a command to erase all previously entered characters.

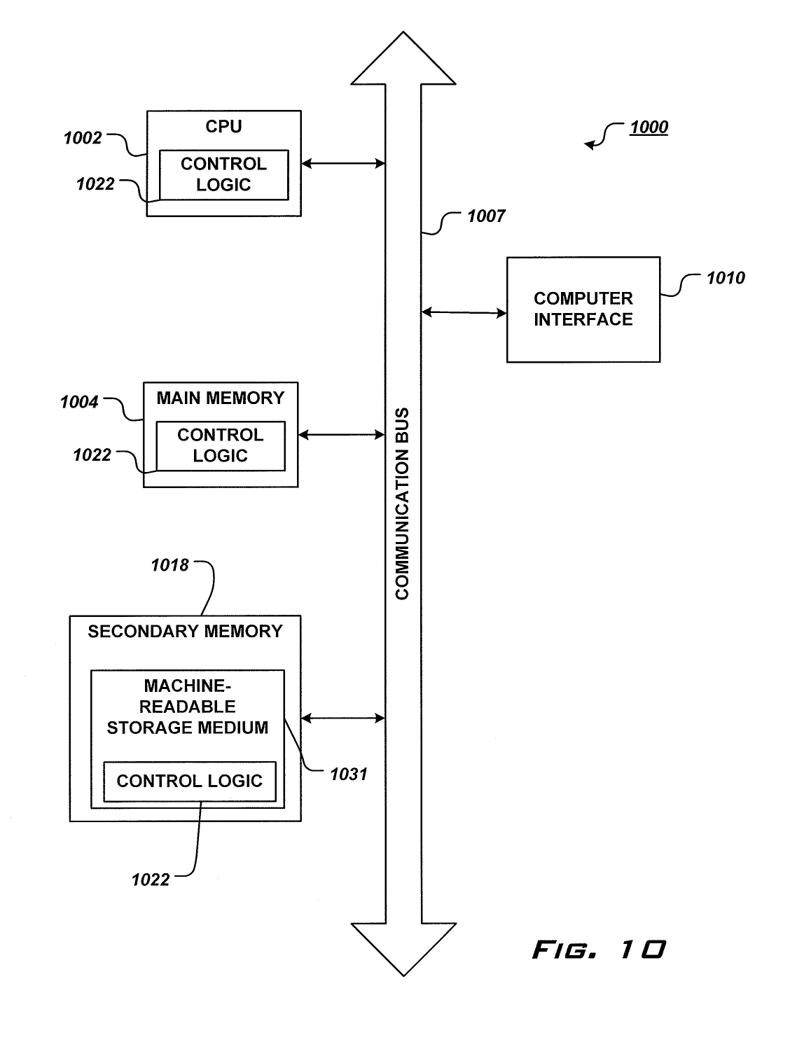

Additionally, as shown in FIG. 9, the glove 10 may be equipped with any of a speaker 91, a video display 93, and a microphone 95, which, in this illustration are shown installed on the palmar side of the glove 10. The dispositions of the components may vary from this illustration according to design choice or necessity. Video display 93 is preferably achieved with a flexible video display, for example, an organic LED (OLED) display. Further, video display may be a flexible touch screen. Each of the components 91, 93, 95 are coupled to the microcontroller 25 as described above. The microcontroller 25 is configured with a computer-based memory on which is stored control logic for controlling operation of the speaker 91, video display 93, and the microphone 95.

The microcontroller 25, as will be appreciated by those skilled in the arts, may be one or more computer-based processors. Such a processor may be implemented by a field programmable gated array (FPGA), application specific integrated chip (ASIC), programmable circuit board (PCB), or other suitable integrated chip (IC) device.

FIG. 10 illustrates a diagrammatic representation of an exemplary computer-based processor 1000 within which a set of instructions, for causing the machine to perform any one or more of the methodologies discussed herein, may be executed.

With reference to FIG. 10, a processor 1000 in effect comprises a computer system. Such a computer system includes, for example, one or more central processing units (CPUs) 1002 that are connected to a communication bus 1007. The computer system 1000 can also include a main memory 1004, such as, without limitation, flash memory, read-only memory (ROM), or random access memory (RAM), and can also include a secondary memory 1018. The secondary memory 1018 can include, for example, a machine-readable storage medium 1031 which may be a hard disk drive and/or a removable storage drive. The removable storage drive reads from and/or writes to a removable storage unit in a well-known manner. The removable storage unit, represents a floppy disk, magnetic tape, optical disk, and the like, which is read by and written to by the removable storage drive. The removable storage unit includes a computer usable storage medium having stored therein computer software and/or data.

The secondary memory 1018 can include other similar means for allowing computer programs or other instructions to be loaded into the computer system. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to the computer system.

Computer programs (also called control logic) 1022 are stored in the main memory and/or secondary memory. Computer programs can also be received via the communications interface. Such computer programs, when executed, enable the computer system to perform certain features of the present invention as discussed herein. In particular, the computer programs, when executed, enable a control processor to perform and/or cause the performance of features of the present invention. Accordingly, such computer programs represent controllers of the computer system.

A processor 1000, and the processor memory, may advantageously contain control logic 1022 or other substrate configuration representing data and instructions, which cause the processor to operate in a specific and predefined manner as, described hereinabove. The control logic 1022 may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. Control logic 1022 may be installed on the memory using a computer interface 1010 couple to the communication bus 1007 which may be any suitable input/output device. The computer interface 1010 may also be configured to allow a user to vary the control logic, either according to pre-configured variations or customizably.

The control logic 1022 conventionally includes the manipulation of data bits by the processor and the maintenance of these bits within data structures resident in one or more of the memory storage devices 1004, 1018. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic 1022 is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor 1000 are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein. Similarly, it may prove advantageous to construct a specialized apparatus to perform the method steps described herein by way of dedicated processor systems with hard-wired logic or programs stored in nonvolatile memory, such as, by way of example, read-only memory (ROM), for example, components such as ASICs, FPGAs, PCBs, microcontrollers, or multi-chip modules (MCMs). Implementation of the hardware state machine so as to perform the functions described herein will be apparent to persons skilled in the relevant art(s).

In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

In another embodiment, features of the lighting system are implemented primarily in hardware using, for example, hardware components such as ASICs, FPGAs, PCBs, microcontrollers, or a multi-chip module (MCM). Implementation of the hardware state machine so as to perform the functions described herein will be apparent to persons skilled in the relevant art(s). In yet another embodiment, features of the invention can be implemented using a combination of both hardware and software.

As described above and shown in the associated drawings, the present invention comprises an apparatus for glove interface apparatus for computer-based devices. While particular embodiments of the apparatus have been described, it will be understood, however, that invention represented in the described apparatus is not limited thereto such description, since modifications may be made by those skilled in the art, particularly in light of the foregoing teachings. It is, therefore, contemplated by the appended claims to cover any such modifications that incorporate those features or those improvements that embody the spirit and scope of the apparatus described above.

What is claimed is:

1. A glove interface apparatus for providing wirelessly transmitted input to a computer-based device, said glove interface apparatus comprising:
a glove including a thumb, a palmar area, and a plurality of fingers;
a thumb contact pad located proximally to the tip of the thumb and comprised of a flexible conductive filament;
a plurality of character contact pads distributed along the sides of the fingers and the palmar area, each of said plurality of character pads comprising a flexible conductive filament;
a control processor responsive to voltage signals from each of said character contact pads when said thumb contact pad completes a circuit with any of said plurality of character contact pads, and
i. wherein each said character contact pad corresponds to a unique voltage signal presented at said control processor; and
ii. wherein said control processor is configured with a computer-readable memory in which is stored data representing said unique voltage signals and said corresponding characters and control logic which, when executed, causes the control processor to issue a character signal as output;
a radio frequency communications module responsive to said character signal from said control processor and configured with a communications protocol compatible with a communications protocol used by a remote computer-based device, such that said radio frequency communications module couples said character signal to said computer-based device.

2. The glove interface apparatus of claim 1, wherein said flexible conductive filament is a conductive thread.

3. The glove interface apparatus of claim 1, further comprising a near field transceiver coupled to an antenna, said antenna located in a finger of said glove.

4. The glove interface apparatus of claim 1, further comprising:
a motion sensor suitable to detect a motion of the glove apparatus in one or more planes of motion and generating a motion signal; and
wherein said control processor is configured to be responsive to said motion signal; and
wherein said computer-readable memory further includes data representing a plurality of commands, each of said commands corresponding to one of a plurality of pre-defined motion signals; and
wherein said control processor is control logic which, when executed, causes the control processor to generate a command signal as output.

5. The glove interface apparatus of claim 4, further comprising at least one of a speaker, a video display, and a microphone.

6. The glove interface apparatus of claim 1, wherein said character pads are distributed about said plurality of fingers according to a priority dictated by the frequency of use of such characters such that frequently used characters are located within easy reach of the thumb contact.

7. The glove interface apparatus of claim 1, wherein said control processor wherein said computer-readable memory is configured to store data representing one or more unique sets of voltage signals and one or more unique phrases that correspond to said one or more unique sets of voltage signals and control logic which, when executed, causes the control processor to issue a signal representing a phrase as output.

8. The glove interface apparatus of claim 7, wherein said flexible conductive filament is a conductive thread.

9. The glove interface apparatus of claim 8, further comprising:
a motion sensor suitable to detect a motion of the glove apparatus in one or more planes of motion and generating a motion signal; and
wherein said control processor is configured to be responsive to said motion signal; and
wherein said computer-readable memory further includes data representing a plurality of commands, each of said commands corresponding to one of a plurality of pre-defined motion signals; and
wherein said control processor is control logic which, when executed, causes the control processor to generate a command signal as output.

10. The glove interface apparatus of claim 9, wherein said character pads are distributed about said plurality of fingers according to a priority dictated by the frequency of use of such characters such that frequently used characters are located within easy reach of the thumb contact.

11. The glove interface apparatus of claim 10, further comprising a near field transceiver coupled to an antenna, said antenna located in a finger of said glove.

12. The glove interface apparatus of claim 11, further comprising at least one of a speaker, a video display, and a microphone.

13. An apparatus comprising:
a computer-based processor configured with:
i. a memory including a plurality of data representing a plurality of unique voltages, and a plurality of corresponding symbol signals; and
ii. control logic causing the processor to generate a symbol signal upon receipt of any of said plurality of voltages;
a glove comprising an electrically conductive thumb contact, and a plurality of electrically conductive contacts distributed along fingers and a palmar area of the glove, said plurality of contacts are configured to present a unique voltage when a circuit is completed with said thumb contact and wherein said unique voltage is coupled to said processor;
an antenna for coupling said symbol signal to a transmit medium, wherein said symbol signal is receivable by a computer-based device.

14. The apparatus of claim 13, wherein said plurality of contacts represent characters of a language and are distributed along said fingers and said palmar area such that circuits between said thumb contact and more frequently used character contacts are more easily completed compared to less frequently use character contacts.

15. The apparatus of claim 14, further comprising at least one of a near-field communication transceiver, a speaker, a flexible video display, and a microphone.

16. The apparatus of claim 15, wherein said unique voltage is coupled to said processor with conductive thread integrated into said glove.

17. The apparatus of claim 16, further comprising a motion sensor for coupling a motion signal to said processor when said glove is moved in one or more planes of motion.

18. The apparatus of claim 17, wherein said memory is configured data representing one or more sets of voltages, each of said sets of voltages corresponding to a set of characters, and wherein said processor is configured to generate a phrase signal upon receipt of a set of voltages.
